(19) United States
(12) Patent Application Publication
(10) Pub. No.: US 2021/0167507 A1
(43) Pub. Date: Jun. 3, 2021

(54) ANTENNA DEVICE AND INVERTED F ANTENNA

(71) Applicant: YOKOWO CO., LTD., Kita-ku, Tokyo (JP)

(72) Inventors: Kenichi YAMADA, Tomioka-Shi, Gunma (JP); Takeshi SAMPO, Tomioka-Shi, Gunma (JP)

(73) Assignee: YOKOWO CO., LTD., Kita-ku, Tokyo (JP)

(21) Appl. No.: 16/641,647

(22) PCT Filed: Jun. 28, 2018
(86) PCT No.: PCT/JP2018/024683

§ 371 Date: Feb. 25, 2020

(30) Foreign Application Priority Data
Aug. 31, 2017 (JP) 2017-167153

(51) Int. Cl. H01Q 9/04; H01Q 1/38; H01Q 9/42; H01Q 5/364

(52) U.S. Cl. CPC H01Q 9/0421; H01Q 5/364; H01Q 9/42; H01Q 1/38

(57) ABSTRACT

An antenna device according to the present invention includes: an inverted F antenna which includes a planar part having a face opposing a grounding surface with a predetermined interval therebetween, a feeding part disposed in a plane forming a predetermined angle with respect to the grounding surface, and a short-circuit part for grounding a portion of the planar part, wherein each of the planar part and the feeding part has a plate shape, and is physically separated from each other; and wherein the planar part and the feeding part are electrically connected each other at a frequency less than or equal to a predetermined frequency.

### TECHNICAL FIELD

The present invention relates to a compact, low-profile antenna device having an inverted F antenna.

### BACKGROUND ART

As a vehicle-mounted antenna device having an inverted F antenna for Long Term Evolution (LTE), for example, the antenna device disclosed in Patent Literature 1 is known. The antenna device is a vehicle-mounted antenna device suitable for installation on the roof of an automobile, and is configured such that three antennas for 3rd Generation (3G)/Long Term Evolution (LTE), digital audio broadcasting (DAB), and the Global Positioning System (GPS) are accommodated in a radome. Of these antennas, the 3G/LTE antenna is an inverted F antenna.

The inverted F antenna disclosed in Patent Literature 1 includes a planar part standing on a ground plate that acts as a grounding surface, and a short-circuit part. A portion of the planar part acts as a feeding point. The antenna device is made to operate in both the low-frequency band from 761 MHz to 960 MHz and the high-frequency band from 1710 MHz to 2130 MHz of LTE.

### PRIOR ART DOCUMENTS

### Patent Literature

[PTL 1] Japanese Patent Laid-Open No. 2013-219757

### SUMMARY OF INVENTION

### Problems to be Solved by the Invention

Recently, demand for LTE has risen, and the d-bound frequency of the low-frequency band has been extended to 699 MHz. Also, the upper-bound frequency of the high-frequency band has also been extended up to the 5 GHz band.

Although the antenna device disclosed in Patent Literature 1 is usable in the low-frequency band and the high-frequency band of LTE, according to the disclosed voltage standing wave ratio (VSWR) characteristics, favorably transmitting and/or receiving a signal in the low-frequency band of LTE is difficult.

Meanwhile, in the high-frequency band, it is difficult to maintain stable reception of a signal over a wide band.

### Solution to the Problems

An antenna device according to the present invention includes: an inverted F antenna which includes a planar part having a face opposing a grounding surface with a predetermined interval therebetween, a feeding part disposed in a plane forming a predetermined angle with respect to the grounding surface, and a short-circuit part for grounding a portion of the planar part, wherein each of the planar part and the feeding part has a plate shape, and is physically separated from each other; and wherein the planar part and the feeding part are electrically connected each other at a frequency less than or equal to a predetermined frequency.

An inverted F antenna according to the present invention includes: a planar part having a face opposing a grounding surface with a predetermined interval therebetween; a feeding part disposed in a plane forming a predetermined angle with respect to the grounding surface; and a short-circuit part for grounding a portion of the planar part, wherein each of the planar part and the feeding part has a plate shape, and is physically separated from each other; and wherein the planar part and the feeding part are electrically connected each other at a frequency less than or equal to a predetermined frequency.

### BRIEF DESCRIPTION OF DRAWINGS

FIG. 1 is a perspective view of an inverted F antenna in an antenna device according to a first embodiment.

FIG. 2 is a schematic diagram illustrating an exemplary configuration of a first switch circuit.

FIG. 3A is an explanatory diagram illustrating the size of a component of the inverted F antenna.

FIG. 3B is an explanatory diagram illustrating the sizes of components of the inverted F antenna.

FIG. 3C is an explanatory diagram illustrating the sizes of components of the inverted F antenna.

FIG. 4 is a perspective view of an inverted F antenna according to a Comparative Example.

FIG. 5 is a graph comparing the VSWR characteristics of an Example and the Comparative Example.

FIG. 6A is a schematic diagram of an inverted F antenna having only a single filter.

FIG. 6B is a graph comparing the VSWR characteristics between Examples.

FIG. 7A is a schematic diagram of an inverted F antenna having a short filter interval.

FIG. 7B is a graph comparing the VSWR characteristics between Examples.

FIG. 8A is a schematic diagram of an inverted F antenna having an elongated feeding part.

FIG. 8B is a graph comparing the VSWR characteristics between Examples.

FIG. 9A is a schematic diagram illustrating a state in which a short-circuit part is selected.

FIG. 9B is a schematic diagram illustrating a state in which a short-circuit part is selected.

FIG. 9C is a schematic diagram illustrating a state in which a short-circuit part is selected.

FIG. 10 is a graph comparing the VSWR characteristics when each of short-circuit parts 15 to 17 is selected.

FIG. 11 is a perspective view of an inverted F antenna according to a second embodiment.

FIG. 12 is a schematic diagram illustrating an exemplary configuration of a second switch circuit.

FIG. 13 is a graph comparing the VSWR characteristics when one of paths p1 to p3 is selectively closed.

FIG. 14A is a schematic diagram illustrating a modification of the short-circuit parts and the second switch circuit.

FIG. 14B is a schematic diagram illustrating a modification of the short-circuit parts and the second switch circuit.

FIG. 15A is an external view of an inverted F antenna according to a third embodiment.

FIG. 15B is an external view of an inverted F antenna according to the third embodiment.

FIG. 15C is an external view of an inverted F antenna according to the third embodiment.

### DESCRIPTION OF EMBODIMENTS

Hereinafter, exemplary embodiments will be described for the case of applying the present invention to an antenna device capable of transmitting and/or receiving signals in the low-frequency band (699 MHz to 960 MHz) and signals in the high-frequency band (1.7 GHz to 2.7 GHz) of LTE. The antenna device can be accommodated in the accommodating space of a radio wave-permeable housing and used as a low-profile vehicle-mounted antenna device.

One object of the embodiments indicated below is to provide a compact, low-profile antenna device and inverted F antenna that enable signals to be transmitted and/or received stably at a low VSWR over a range from near the lowest frequency in the low-frequency band to near the highest frequency of the high-frequency band of LTE, for example.

### First Embodiment

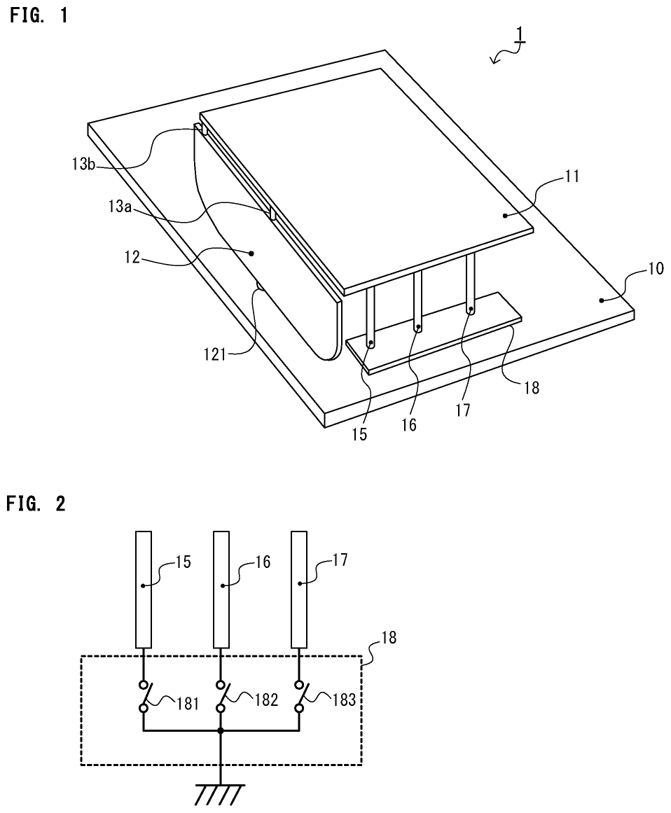

FIG. 1 is a perspective view of an antenna device according to the first embodiment. The antenna device is provided with an inverted F antenna 1 as a main component. The inverted F antenna 1 includes a planar part 11, a feeding part 12, short-circuit parts 15, 16, and 17, and a first switch circuit 18, which are provided above a substrate 10 having a metal face, the surface of the metal face being at ground potential during operation (hereinafter referred to as the “grounding surface”). For the substrate 10, a metal-plated resin may be used, but the substrate 10 may also be a metal plate such as a copper plate.

The planar part 11 and the feeding part 12 are physically separated plate-like elements. In the example illustrated in the diagram, the two parts have mutually different shapes and sizes, but are not always required to be configured in this way. The short-circuit parts 15, 16, and 17 as well as the first switch circuit 18 are components for selectively grounding a portion of the planar part 11 and thereby switching the low-frequency band of LTE among three frequency bands. In the present embodiment, the three frequency bands are referred to as the first sub-band, the second sub-band, and the third sub-band for the sake of convenience. The first sub-band is the frequency band from 699 MHz to 803 MHz. The second sub-band is the frequency band from 791 MHz to 894 MHz. The third sub-band is the frequency band from 880 MHz to 960 MHz.

The planar part 11 is a rectangular plate having a metal face (hereinafter referred to as the “back face”) opposing the grounding surface with a predetermined interval therebetween. The feeding part 12 is a metal plate disposed in a plane forming a predetermined angle (for example, approximately 90 degrees) with respect to the grounding surface. The feeding part 12 has an edge (hereinafter referred to as the “proximity edge”) that does not contact, but is in close proximity to, one of the edges of the planar part 11, while the remaining portions are fin-shaped.

The term “fin-shaped” refers to a shape in which at least one of the corner areas of the metal plate is arc-shaped, or alternatively, a shape in which two adjacent corner areas are arc-shaped. In this embodiment, the metal plate is elongated, and among the corner areas, the two corner areas near the grounding surface are arced with different radii of curvature. A feeding terminal 121 is formed at the portion where the arc with the larger radius of curvature begins. The two portions of the feeding part 12 may also be arced with the same radius of curvature, or the feeding part 12 may have a single arced portion.

The reason why the proximity edge of the feeding part 12 is longer than the fin-shaped edges is to secure a long filter interval for filters 13a and 13b as described later.

The planar part 11 and the feeding part 12 are metal plates such as copper plates, but because these parts are used in frequency bands where a surface effect is obtained, a metal-plated resin may also be used.

The planar part 11 is designed such that the electrical length, which is the sum of the lengths of the long and short edges in the case of the present example, is a length approximately ¼ of a wavelength XL of the lowest frequency (699 MHz) in the low-frequency band of LTE. On the other hand, the feeding part 12 is designed such that the electrical length, which is sum of the lengths of the edges in the case of the present example, is a length approximately ¼ of a wavelength λ_{H} of the lowest frequency (1.7 GHz) in the high-frequency band of LTE. By setting the planar part 11 and the feeding part 12 to the above sizes, signals in a frequency band above the lowest frequency of the low-frequency band and below the highest frequency of the high-frequency band can be made to resonate in a useful spectrum space.

The physically separated planar part 11 and feeding part 12 are electrically connected via the two filters 13a and 13b. The term “electrically connected” does not mean a state in which any slight amount of current flows, rather, the term is directed to a state in which the planar part 11 and the feeding part 12 function as an antenna element at a frequency in use which is lower than or equal to a predetermined frequency. If only a tiny amount of current flows, a substantial electrical connection is not formed. Each of the filters 13a and 13b operates as a high-frequency cutoff filter which cuts off frequencies exceeding the lowest frequency (1.7 GHz) of the high-frequency band of LTE. Additionally, each of the filters 13a and 13b is electrically connected at a frequency equal to or lower than a predetermined frequency, namely the highest frequency of the low-frequency band of LTE (in this example, 960 MHz in the third sub-band), and each operates as an antenna element.

The filters 13a and 13b can be configured with only inductive reactance in a simple configuration. In this case, the inductance of the filters 13a and 13b is set to approximately 7.5 nH in consideration of factors such as the floating capacitance. The arrangement interval of the two adjacent filters 13a and 13b is set to a predetermined interval or greater, namely a distance at which the operations of the filter components do not influence each other. This arrangement interval (hereinafter referred to as the “filter interval”) is preferably as large as possible.

The short-circuit parts 15, 16, and 17 are provided to selectively receive the above three sub-bands in the low-frequency band of LTE. One end of each of the short-circuit parts 15, 16, and 17 is joined to respective positions at different distances from a site close to the feeding part 12 on the face orthogonal to the feeding part 12 on the back face near one of the short edges of the planar part 11. In other words, electrical continuity with the planar part 11 is achieved at the above positions. The other ends of the short-circuit parts 15, 16, and 17 are selectively grounded by the first switch circuit 18. In the following description, the three short-circuit parts are referred to as the first short-circuit part 15, the second short-circuit part 16, and the third short-circuit part 17 in order from the end near the feeding part 12 along the short edge of the planar part 11.

FIG. 2 is a schematic diagram illustrating an exemplary configuration of the first switch circuit 18. The other ends of the first short-circuit part 15, the second short-circuit part 16, and the third short-circuit part 17 are electrically connected to one end, respectively, of three switching elements 181, 182, and 183 of the first switch circuit 18. The other ends of the switching elements 181, 182, and 183 are a common terminal in electrical continuity with the grounding surface. The switching elements 181, 182, and 183 are controlled such that only one has electrical continuity (i.e., closed), according to an external signal transmitted from an electronic device in the vehicle, for example.

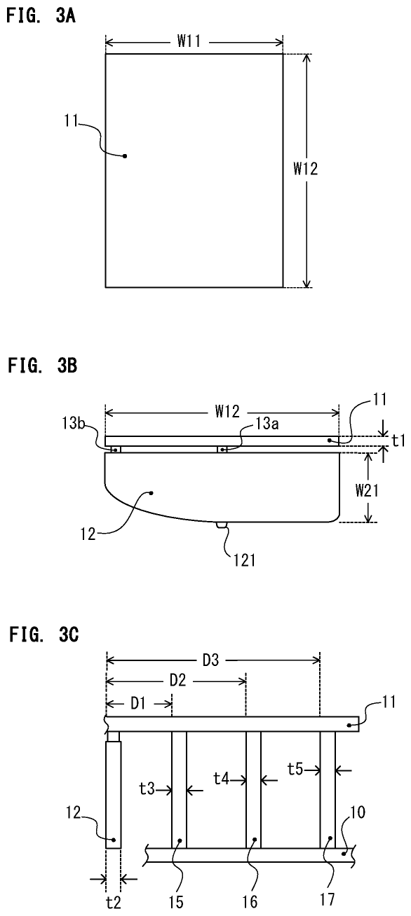

Exemplary sizes of the components of the inverted F antenna 1 will be described. FIG. 3A is a top view of the inverted F antenna 1, while FIG. 3B is a side view of the inverted F antenna 1 from the direction of the feeding part 12, and FIG. 3C is a side view of the inverted F antenna 1 from the direction of the short-circuit parts 15, 16, and 17.

The planar part 11 is a rectangular plate having a short edge W11 of 30 mm, a long edge W12 of 42.5 mm, and a thickness t1 of 10μ (microns). The proximity edge of the feeding part 12 is of the same size as the long edge W12 of the planar part 11, and the feeding part 12 has a width W21 of 23.5 mm and a thickness t2 of 10μ (microns).

For this reason, in the case of accommodating the inverted F antenna 1 in a housing, the height from the grounding surface to the housing can be set to 25 mm.

The feeding terminal 121 projects outward slightly in the direction of the grounding surface, but this projection can be avoided by bending the feeding terminal 121.

Also, in the case of disposing a resin onto the substrate 10 and attaching the planar part 11 and the feeding part 12 to the resin, the size of each component is appropriately modified according to the effective wavelength that is shortened by the effective dielectric constant considering the dielectric constant of the resin.

The short-circuit parts 15, 16, and 17 are square columns (having a square cross-section) with respective widths t3, t4, and t5 of 1 mm. However, circular columns or some other cross-sectional shape may also be used. Starting from the end near the feeding part 12 along the short edge of the planar part 11, a distance D1 to the first short-circuit part 15 is 1 mm, a distance D2 to the second short-circuit part 16 is 6 mm, and a distance D3 to the third short-circuit part 17 is 21 mm.

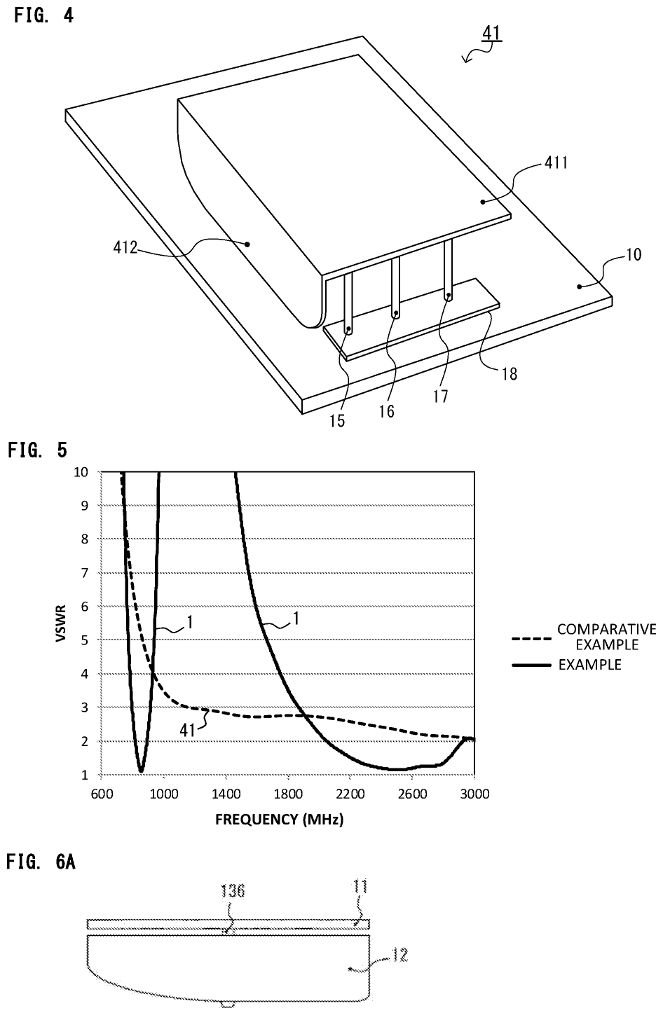

One characteristic of the inverted F antenna 1 of the first embodiment is that the planar part 11 and the feeding part 12 are physically separated plates, which are electrically connected at a frequency lower than or equal to a predetermined frequency, such as a frequency lower than or equal to the highest frequency of the low-frequency band of LTE, for example. To investigate the effects of such a configuration, the inventors created an inverted F antenna 41 illustrated in FIG. 4 as a Comparative Example. The inverted F antenna 41 of the Comparative Example has the same material, the same shape and size, and the same configuration as the inverted F antenna 1 of the first embodiment, except that a planar part 411 and a feeding part 412 are cast in a single piece. The material, the sizes of the long and short edges, and the thickness of the planar part 411 are the same as the planar part 11. The material, the sizes of the long and short edges, and the thickness of the feeding part 412 are the same as the feeding part 12.

FIG. 5 is a graph comparing the voltage standing wave ratio (VSWR) characteristics of an Example and the Comparative Example of the inverted F antenna 1, and illustrates results calculated by a predetermined simulator. The solid line represents the VSWR characteristics of the inverted F antenna 1 according to the Example (hereinafter referred to as “Example 1”), while the dashed line represents the VSWR characteristics of the inverted F antenna 41 according to the Comparative Example (hereinafter referred to as “Comparative Example 41”). The relationship (excerpt) between the frequency (MHz) and the VSWR is as follows.

| Frequency (MHz) | Comparative Example 41 | Example 1 |
|---|---|---|
| 747.5 | 8.67 | 8.21 |
| 802.5 | 6.45 | 2.43 |
| 815.0 | 6.08 | 1.92 |
| 850.0 | 5.24 | 1.09 |
| 887.5 | 4.58 | 1.97 |
| 900.0 | 4.40 | 2.49 |
| . . . | | |
| 1907.5 | 2.75 | 2.74 |
| 2050.0 | 2.70 | 1.98 |
| 2100.0 | 2.66 | 1.80 |
| 2200.0 | 2.58 | 1.51 |
| 2500.0 | 2.33 | 1.15 |
| 2600.0 | 2.25 | 1.20 |
| 2800.0 | 2.15 | 1.36 |
| 2900.0 | 2.12 | 1.89 |
| 2960.0 | 2.09 | 2.09 |

In this way, in Example 1, the VSWR is significantly less than Comparative Example 41 in both the low-frequency band (first sub-band, second sub-band, third sub-band) and the high-frequency band. In other words, it is confirmed that by configuring the inverted F antenna 1 like in Example 1, the VSWR is lowered, and an effect of transmitting and/or receiving LTE signals more easily over a wide band is obtained.

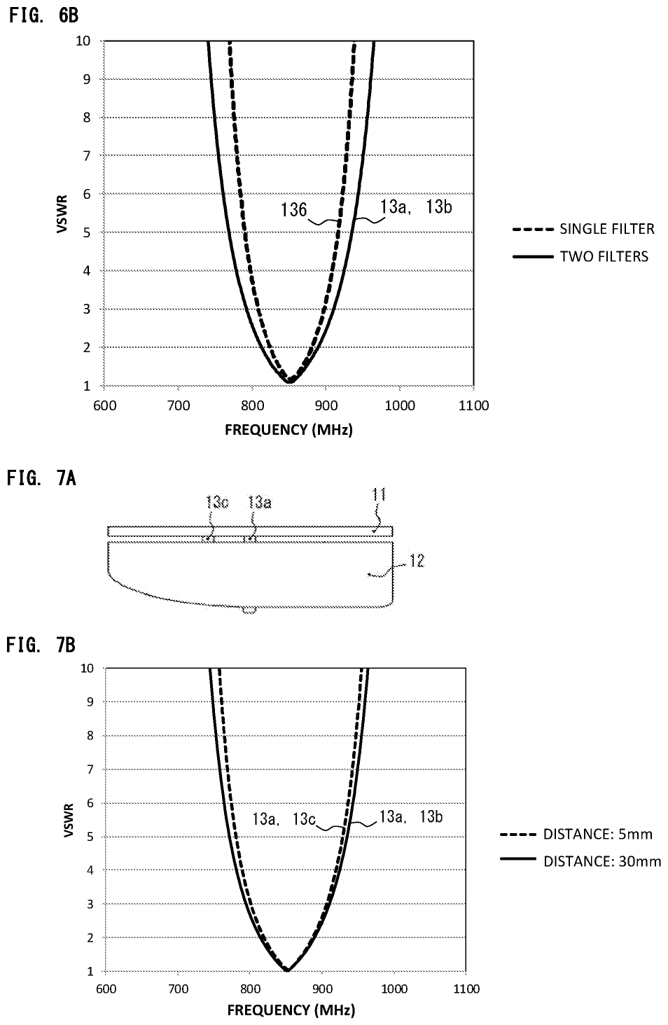

FIG. 6A illustrates an exemplary configuration of an inverted F antenna according to another Comparative Example using a single filter 136 instead of the two filters 13a and 13b in Example 1. The filter 136 is disposed at the same position as the filter 13a.

In Example 1, the two filters 13a and 13b are filters having an inductance of 7.5 nH, but for the filter 136 of the Comparative Example illustrated in FIG. 6A to achieve the same frequency cutoff effect as Example 1, a filter having an inductance of 15 nH is used.

FIG. 6B is a graph comparing the VSWR characteristics of the other Comparative Example above which includes a single filter (only the filter 136) and Example 1 which includes the two filters 13a and 13b, and illustrates results calculated in the low-frequency band by a predetermined simulator. The solid line represents the VSWR characteristics of Example 1 using the two filters 13a and 13b, while the dashed line represents the VSWR characteristics of the Comparative Example using the single filter 136. The relationship (excerpt) between the frequency (MHz) and the VSWR is as follows.

| Frequency (MHz) | Other Comparative Example | Example 1 |
|---|---|---|
| 815.0 | 2.68 | 1.92 |
| 825.0 | 1.96 | 1.59 |
| 850.0 | 1.19 | 1.09 |
| 880.0 | 2.07 | 1.80 |
| 887.5 | 2.34 | 1.97 |

In this way, it is confirmed that by electrically connecting the planar part 11 and the feeding part 12 via the two filters 13a and 13b, like in Example 1, as compared to the case of using the single filter 136, the VSWR in the low-frequency band of LTE can be decreased, and furthermore, the frequency band where the VSWR is less than 2 can be greatly expanded.

This trend is almost similar in the high-frequency band of LTE, and the relationship (excerpt) between the frequency (MHz) and the VSWR is as follows.

| Frequency (MHz) | Other Comparative Example | Example 1 |
|---|---|---|
| 1990.0 | 1.99 | 2.27 |
| 2047.5 | 1.82 | 1.99 |
| 2352.5 | 1.33 | 1.24 |
| 2505.0 | 1.39 | 1.15 |
| 2760.0 | 1.99 | 1.28 |
| 2920.0 | 2.72 | 1.99 |

In the Example of the inverted F antenna 1, a case of using the two filters 13a and 13b is given as an example, but there may also be three or more filters. However, the value of the inductance needs to be altered according to the number of filters and the type of filter components.

In the Example of the inverted F antenna 1, the interval between the two filters 13a and 13b is set to the length of the short edge of the planar part 11, namely 30 mm. To investigate the effect of this configuration, the inventors created an inverted F antenna according to another Comparative Example in which the above interval is changed. An exemplary configuration of the inverted F antenna according to the other Comparative Example is illustrated in FIG. 7A. In the example of FIG. 7A, the filter 13a is left unchanged, but a filter 13c is disposed at a position forming an interval of 5 mm. The filter components of the filter 13c are similar to the filter 13b.

FIG. 7B is a graph comparing the VSWR characteristics of the other Comparative Example with a filter interval of 5 mm and Example 1 with a filter interval of 30 mm, and illustrates results calculated by a predetermined simulator. The solid line represents the VSWR characteristics of Example 1 using the filters 13a and 13b, while the dashed line represents the VSWR characteristics of the Comparative Example using the filters 13a and 13c. The relationship between the frequency (MHz) and the VSWR is as follows.

| Frequency (MHz) | Other Comparative Example | Example 1 |
|---|---|---|
| 815.0 | 2.68 | 1.92 |
| 825.0 | 1.96 | 1.59 |
| 850.0 | 1.19 | 1.09 |
| 880.0 | 1.96 | 1.72 |
| 882.5 | 2.07 | 1.80 |
| 887.5 | 2.34 | 1.97 |

In this way, it is confirmed that by setting the filter interval between the filters 13a and 13b to 30 mm like in Example 1, compared to the case of setting the filter interval to 5 mm, the VSWR in the low-frequency band of LTE can be decreased, and furthermore, the frequency band where the VSWR is less than 2 can be greatly expanded.

This trend is almost similar in the high-frequency band of LTE. The relationship (excerpt) between the frequency (MHz) and the VSWR is as follows.

| Frequency (MHz) | Other Comparative Example | Example 1 |
|---|---|---|
| 2022.5 | 1.99 | 2.14 |
| 2057.5 | 1.87 | 1.99 |
| 2415.0 | 1.28 | 1.16 |
| 2440.0 | 1.28 | 1.14 |
| 2475.0 | 1.31 | 1.11 |
| 2550.0 | 1.38 | 1.11 |
| 2745.0 | 1.98 | 1.19 |
| 2765.0 | 2.15 | 1.20 |
| 2957.5 | 1.82 | 1.80 |

In Example 1, the filter interval between the two filters 13a and 13b is set to 30 mm, but obviously the filter interval may also be 30 mm or more.

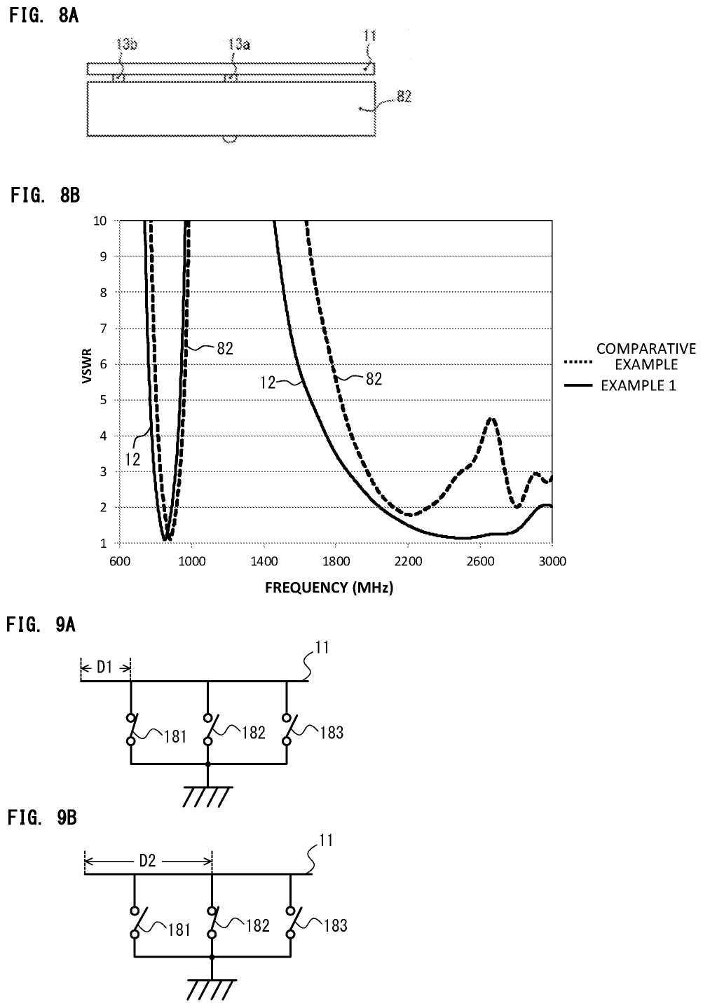

In Example 1, the portion of the edges other than the proximity edge of the feeding part 12 are fin-shaped, and to investigate the effect of this configuration, the inventors created an inverted F antenna according to another Comparative Example in which the shape of the feeding part is different. An exemplary configuration of the inverted F antenna according to the other Comparative Example is illustrated in FIG. 8A. The example in FIG. 8A illustrates a rectangular feeding part 82 having an electrical length, or the sum of the lengths of the edges, which is the same as that of the feeding part 12 of Example 1. The material and thickness of the feeding part 82, the planar part 11, and the filter interval between the filters 13a and 13b are similar to Example 1.

FIG. 8B is a graph comparing the VSWR characteristics of the other Comparative Example with a differently shaped feeding part and Example 1, and illustrates results calculated by a predetermined simulator. The solid line represents the VSWR characteristics in the case of using the feeding part 12 shaped like in Example 1, while the dashed line represents the VSWR characteristics in the case of using the rectangular feeding part 82. The relationship (excerpt) between the frequency (MHz) and the VSWR is as follows.

| Frequency (MHz) | Other Comparative Example | Example 1 |
|---|---|---|
| 815.0 | 3.74 | 1.92 |
| 850.0 | 1.80 | 1.09 |
| 880.0 | 1.11 | 1.72 |
| 887.5 | 1.21 | 1.97 |
| 912.5 | 1.96 | 3.17 |
| . . . | | |
| 2047.5 | 2.35 | 1.99 |
| 2122.5 | 1.99 | 1.73 |
| 2212.5 | 1.79 | 1.47 |
| 2662.5 | 4.49 | 1.26 |
| 2802.5 | 2.01 | 1.37 |

Because the feeding part 12 is designed to be a size which resonates in the high-frequency band of LTE, as the above Comparative Example of the VSWR characteristics in the high-frequency band clearly demonstrates, the difference in the shape exerts a large influence in the high-frequency band of LTE. In other words, it is confirmed that by making the edges of the feeding part 12 that point toward the grounding surface fin-shaped, compared to the Comparative Example, the VSWR in the high-frequency band of LTE can be decreased significantly, and furthermore, the band where the VSWR is less than 2 can be expanded stably. This trend is almost similar in the low-frequency band of LTE.

Next, the way in which the electrical characteristics of the inverted F antenna 1 are influenced by the selective arrangement of the short-circuit parts 15, 16, and 17 will be described. Herein, the VSWR characteristics are cited as an example of the electrical characteristics.

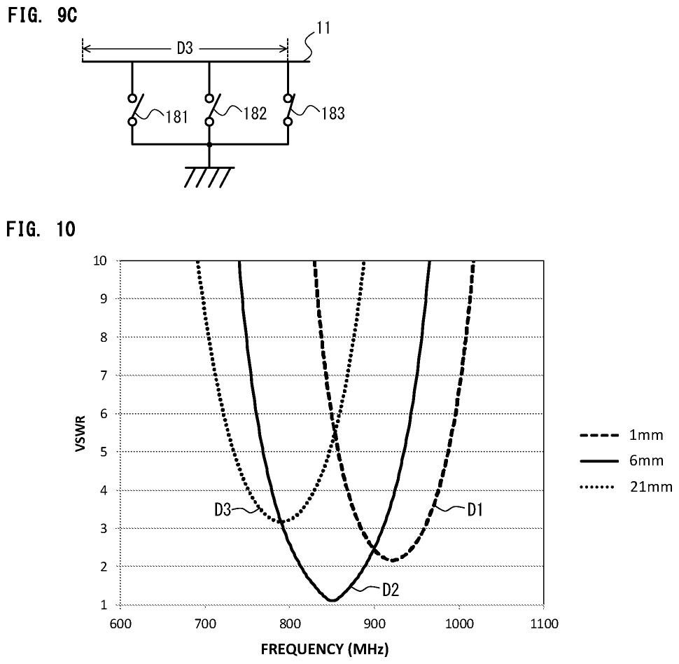

The first switch circuit 18 includes the three switching elements 181 to 183, as described earlier. FIG. 9A illustrates the operating behavior of the first switch circuit 18 when a portion of the planar part 11 is grounded via the first short-circuit part 15. In the first switch circuit 18, when only the first switching element 181 is closed, the second switching element 182 and the third switching element 183 are open. For this reason, only the portion which is within the 1 mm distance D1 from the end of the planar part 11 is in electrical continuity with the grounding surface.

Similarly, FIG. 9B illustrates the operating behavior of the first switch circuit 18 when a portion of the planar part 11 is grounded via the second short-circuit part 16. In the first switch circuit 18, only the second switching element 182 is closed, while the first switching element 181 and the third switching element 183 are open. For this reason, only the portion which is within the 6 mm distance D2 from the end of the planar part 11 is in electrical continuity with the grounding surface.

Similarly, FIG. 9C illustrates the operating behavior of the first switch circuit 18 when a portion of the planar part 11 is grounded via the third short-circuit part 17. In the first switch circuit 18, only the third switching element 183 is closed, while the first switching element 181 and the second switching element 182 are open. For this reason, only the portion which is within the 21 mm distance D3 from the end of the planar part 11 is in electrical continuity with the grounding surface.

FIG. 10 is a graph comparing the VSWR characteristics when each of the short-circuit parts 15 to 17 is selected, and illustrates results calculated by a predetermined simulator. The dashed line represents the VSWR characteristics for the case where the distance from the end of the short edge of the planar part 11 to the grounded site is D1 (1 mm: 1/30 the length of the short edge), while the solid line represents the case where the distance is D2 (6 mm: ⅕ the length of the short edge), and the dotted line represents the case where the distance is D3 (21 mm: approximately ⅔ the length of the short edge).

In the case where the distance D1 is selected, the minimum value of the VSWR is 2.16 (frequency 922.5 MHz). Also, the VSWR is less than 5 from 857.5 MHz to 985.0 MHz (bandwidth 127.5 MHz), the VSWR is less than 4 from 870.0 MHz to 975.0 MHz (bandwidth 105 MHz), and the VSWR is less than 3 from 885 MHz to 975.5 MHz (bandwidth 90 MHz). In other words, the above demonstrates that in the case of transmitting and/or receiving signals in the third sub-band (880 MHz to 960 MHz) of the low-frequency band of LTE, it is sufficient for the first switch circuit 18 to close only the first switching element 181.

When only the first switching element 181 is closed, the VSWR in the high-frequency band of LTE is less than 3 (2.99) at 1905 MHz, less than 2 (1.99) at 2085 MHz, and approximately 1.16 from 2492.5 MHz to 2520 MHz.

Also, from 2037.5 MHz to 3000.0 MHz, the VSWR is at most 2.22 (bandwidth 962.5 MHz or more). In other words, it is possible to transmit and/or receive signals stably not only in the low-frequency band but also in the high-frequency band of LTE.

In the case where the distance D2 is selected, the minimum value of the VSWR is 1.09 (frequency 850.0 MHz). Also, the VSWR is less than 5 from 770.0 MHz to 932.5 MHz (bandwidth 162.5 MHz), the VSWR is less than 4 from 780.0 MHz to 922.5 MHz (bandwidth 142.5 MHz), and the VSWR is less than 3 from 885 MHz to 975.5 MHz (bandwidth 90.5 MHz). In other words, the above demonstrates that in the case of transmitting and/or receiving signals in the second sub-band (791 MHz to 894 MHz) of the low-frequency band of LTE, it is sufficient for the first switch circuit 18 to close only the second switching element 182. Particularly, with the distance D2, the VSWR is less than 1.1 at 850.0 MHz as well as several dozen MHz before and after 850.0 MHz, and maximum performance (transmitting and/or receiving capability) in the low-frequency band of LTE can be exhibited.

When only the second switching element 182 is closed, the VSWR in the high-frequency band of LTE is less than 3 (2.99) at 1867.5 MHz, less than 2 (1.99) at 2047.5 MHz, and approximately 1.15 from 2482.5 MHz to 2530 MHz.

Also, the VSWR is less than 2 from 2047.5 MHz to 2920.0 MHz (bandwidth 872.5 MHz). In other words, high performance is exhibited not only in the low-frequency band but also in the high-frequency band of LTE.

In the case where the distance D3 is selected, the minimum value of the VSWR is 3.19 (frequency 790.0 MHz). Also, the VSWR is less than 5 from 735.0 MHz to 845.0 MHz (bandwidth 110.0 MHz), and the VSWR is less than 4 from 752.5 MHz to 827.5 MHz (bandwidth 75.5 MHz). In other words, the above demonstrates that in the case of transmitting and/or receiving signals in the first sub-band (699 MHz to 803 MHz) of the low-frequency band of LTE, it is sufficient for the first switch circuit 18 to close only the third switching element 183.

When only the third switching element 183 is closed, the VSWR in the high-frequency band of LTE is less than 2 (1.99) at 1752.5 MHz, less than 1.2 (1.19) at 1937.5 MHz, a minimum (1.03) at 2017.5 MHz, and less than 1.09 from 1975.0 MHz to 2065 MHz.

Also, the VSWR is less than 2 from 1752.5 MHz to 3000.0 MHz (bandwidth 1247.5 MHz), and the VSWR is less than 1.1 from 1975.0 MHz to 2065.0 MHz (bandwidth 90.0 MHz). In other words, in the low-frequency band of LTE, the VSWR is slightly higher than the case where the distance D1 or D2 is selected, but in the high-frequency band of LTE, maximum performance is exhibited.

The results of comparing the inverted F antenna according to each Comparative Example in the first embodiment and Example 1 of the inverted F antenna 1 are summarized as follows.

### (1-1) Relationship Between Planar Part 11 and Feeding Part 12

In Example 1, the planar part 11 which is substantially parallel to the grounding surface and the feeding part 12 disposed at an angle of approximately 90 degrees with respect to the grounding surface has a plate shape are configured as physically separated plates, and are substantially electrically connected at a frequency equal to or less than the highest frequency of the low-frequency band of LTE. For this reason, it is easy to create an inverted F antenna having an expanded frequency band in which the VSWR is less than 1.1 (FIG. 5) while also keeping a low profile (a height of less than 25 mm from the grounding surface). When the angle with respect to the grounding surface of the planar part 11 is less than 90 degrees, the inverted F antenna can have an even lower profile.

Particularly, in Example 1, the planar part 11 is rectangular, and the feeding part 12 has a proximity edge in proximity to one of the edges of the planar part 11, while the other edges of the feeding part 12 are fin-shaped. For this reason, the inverted F antenna 1 in which the usable frequency bands in the low-frequency band and the high-frequency band of LTE are expanded and the VSWR is stably low is achieved (FIGS. 8A and 8B).

### (1-2) Filters 13a and 13b

In Example 1, two or more filters which electrically connect the physically separated planar part 11 and feeding part 12 at a frequency less than or equal to a predetermined frequency are provided, and in addition, the filter interval between the two adjacent filters is made as large as possible (equal to or greater than the size of the short edge of the planar part 11, for example). For this reason, the spectrum space of signals which can be transmitted and/or received can be expanded while still keeping the VSWR low in a stable manner (FIGS. 6B and 7B).

### (1-3) Short-Circuit Parts 15, 16, 17 and First Switch Circuit 18

In Example 1, for example, the first short-circuit part 15 is provided at a position 1 mm away ( 1/30 the length of the short edge of the planar part 11) from the end of the short edge, the second short-circuit part 16 is provided at a position 6 mm away (⅕ the length of the short edge), the third short-circuit part 17 is provided at a position 21 mm away ( 21/30 the length of the short edge), and the first switch circuit 18 is configured to selectively put one of the short-circuit parts in electrical continuity with the grounding surface. For this reason, it is possible to switch the sub-band usable in the low-frequency band of LTE simply by switching the current distribution. For this reason, it is not necessary to attain impedance matching. Furthermore, in addition to the switching of the sub-band in the low-frequency band of LTE, the VSWR is also decreased in the high-frequency band of LTE and the usable frequency band is expanded, thereby making it possible to transmit and/or receive signals over a wide band of LTE with a low VSWR.

Particularly, in Example 1, in the case where the second short-circuit part 16 is selected, the VSWR in the low-frequency band of LTE falls to 1.09, while in addition, the bandwidth in which the VSWR is less than 4 is expanded to 142.5 MHz. For this reason, maximum performance can be exhibited in the low-frequency band of LTE.

Also, in the case where the third short-circuit part 17 is selected, maximum performance can be exhibited in the high-frequency band of LTE.

Although technologies other than present invention that enable the transmission and/or reception of signals in a plurality of frequency bands using a single inverted F antenna exist, most are technologies that attain impedance matching by providing a matching circuit or the like on the side of the electronic circuit connected to the inverted F antenna, and matching loss caused by component insertion is unavoidable. Also, adjusting the frequency band with a matching circuit has limits in how far the bandwidth can be expanded from the low-frequency band to the high-frequency band of LTE. This is because keeping the VSWR under 5 in all frequency bands is difficult.

In contrast, the inverted F antenna 1 of the first embodiment adopts a configuration which changes the current distribution of the planar part 11 and the feeding part 12 as seen by the feeding terminal 121 by selectively switching to one of the three short-circuit parts 15, 16, and 17. For this reason, it is extremely easy to expand the bandwidth while keeping the VSWR at a fixed value or less, without the need to provide a matching circuit (without producing matching loss).

### Second Embodiment

Next, a second embodiment of the present invention will be described. FIG. 11 is a perspective view of an inverted F antenna according to the second embodiment. In an inverted F antenna 2 of the second embodiment, only the configuration for switching the current distribution is different. For this reason, parts that are the same as the components indicated in the first embodiment will be denoted with the same signs, and duplicate description will be omitted.

The inverted F antenna 2 includes a single short-circuit part 25 and a second switch circuit 28. One end of the short-circuit part 25 is joined at a position where the VSWR is a minimum at a specific frequency, or in other words, at a position the distance D2 (6 mm) away from the end of one of the short edges of the planar part 11 on the back face of the planar part 11. The short-circuit part 25 has the same material, shape, size, and disposed position as the second short-circuit part 16 of the first embodiment.

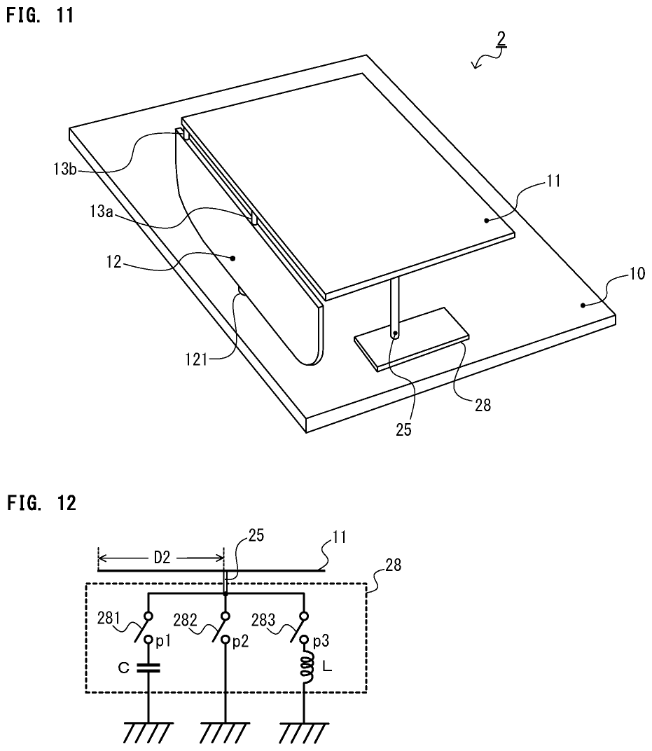

FIG. 12 is a schematic diagram illustrating an exemplary configuration of the second switch circuit 28. In the second switch circuit 28, a common terminal is electrically connected to the short-circuit part 25. The position of the short-circuit part 25 is as described earlier. Also, the second switch circuit 28 is provided with a path p1 of a capacitor C having one end connected to a first switching element 281 and the other end grounded, a path p2 having one end connected to a second switching element 282 and the other end simply grounded, and a path p3 of a coil L having one end connected to a third switching element 283 and the other end grounded. The reactance of the capacitor C is 3 pF, and the inductance of the coil L is 30 nH.

Each of the switching elements 281, 282, and 283 is controlled such that only one has electrical continuity (i.e., closed), according to an external signal transmitted from an electronic device in the vehicle, for example.

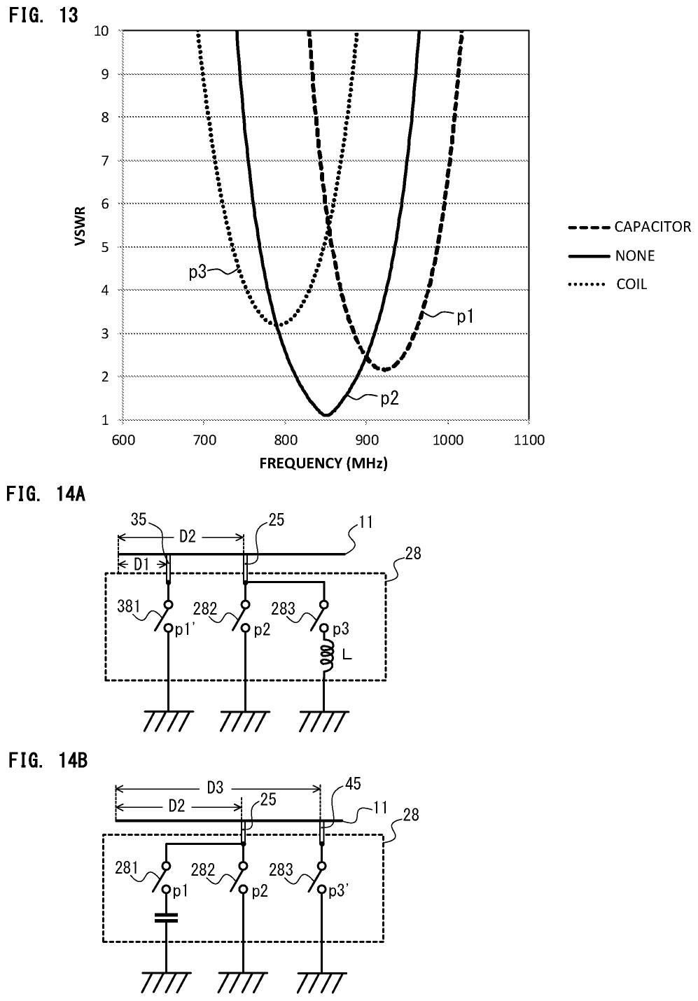

FIG. 13 is a graph comparing the VSWR characteristics when one of the paths p1 to p3 is selectively closed, and illustrates results calculated by a predetermined simulator. The dashed line represents the VSWR characteristics for the case when the path p1 is selected, the solid line represents the case for the path p2, and the dotted line represents the case for the path p3. Although there is only one short-circuit part 25, by selectively switching to one of the paths p1, p2, and p3 with the second switch circuit 28, the VSWR characteristics become the same as those of the inverted F antenna 1 according to the first embodiment illustrated in FIG. 10.

In other words, in the case where the path p1 is selected, the phase is advanced compared to the path p2 because of the capacitor C, causing the short-circuit part 25 to operate as though the short-circuit part 25 existed at the distance D1 (1 mm: 1/30 the length of the short edge of the planar part 11) in the first embodiment, and thereby resulting in the same VSWR characteristics as the distance D1 in FIG. 10.

In the case where the path p2 is selected, the short-circuit part 25 is directly grounded, thereby resulting in the same VSWR characteristics as the distance D2 (6 mm: ⅕ the length of the short edge of the planar part 11) in FIG. 10.

In the case where the path p3 is selected, the phase is retarded compared to the path p2 because of the coil L, causing the short-circuit part 25 to operate as though the short-circuit part 25 existed at the distance D3 (21 mm: approximately ⅔ the length of the short edge of the planar part 11) in the first embodiment, and thereby resulting in the same VSWR characteristics as the distance D3 in FIG. 10.

In the second switch circuit 28, because each of the paths p1 to p3 can be configured easily with patterning technology and component interconnects, and because only a single short-circuit part 25 is sufficient, production is simple compared to the inverted F antenna 1 of the first embodiment. There is also an advantage of an increased freedom in the layout when the inverted F antenna 2 is accommodated in the housing.

As a modification of the second embodiment, it is also possible to combine two short-circuit parts. FIG. 14A is a schematic diagram illustrating a first modification. The first modification illustrated in FIG. 14A is configured such that, in addition to the short-circuit part 25 illustrated in FIG. 12, another short-circuit part 35 is provided at a site a different distance away (in this example, the site corresponding to the above distance D1) from the end near the feeding terminal 121 along the short edge of the planar part 11. Furthermore, the second switch circuit 28 is configured to selectively put one of the two paths p2 and p3 having different electrical lengths from the grounding surface in electrical continuity with the short-circuit part 25, or alternatively, instead of the short-circuit part 25, the second switch circuit 28 is configured to put a path p1′ of the other short-circuit part 35 in electrical continuity.

FIG. 14B is a schematic diagram illustrating a second modification. The second modification illustrated in FIG. 14B is configured such that, in addition to the short-circuit part 25 illustrated in FIG. 12, another short-circuit part 45 is provided at a site a different distance away (in this example, the site corresponding to the above distance D3) from the end near the feeding terminal 121 of the planar part 11. Furthermore, the second switch circuit 28 is configured to selectively put one of the two paths p1 and p2 having different electrical lengths from the grounding surface in electrical continuity with the short-circuit part 25, or alternatively, instead of the short-circuit part 25, the second switch circuit 28 is configured to put a path p3′ of the other short-circuit part 45 in electrical continuity.

According to the configurations in FIGS. 14A and 14B, substantially the same effects as the inverted F antenna 2 of the second embodiment illustrated in FIG. 12 can be exhibited.

### Third Embodiment

Next, a third embodiment of the present invention will be described. The first embodiment illustrates an example of the feeding part 12 in which the proximity edge is the same size as the long edge of the rectangular planar part 11 and the ends of the proximity edge exist at the same positions as the ends of the planar part 11. However, in the third embodiment, an example of an inverted F antenna having a feeding part which is different from the feeding part 12 of the first embodiment will be described.

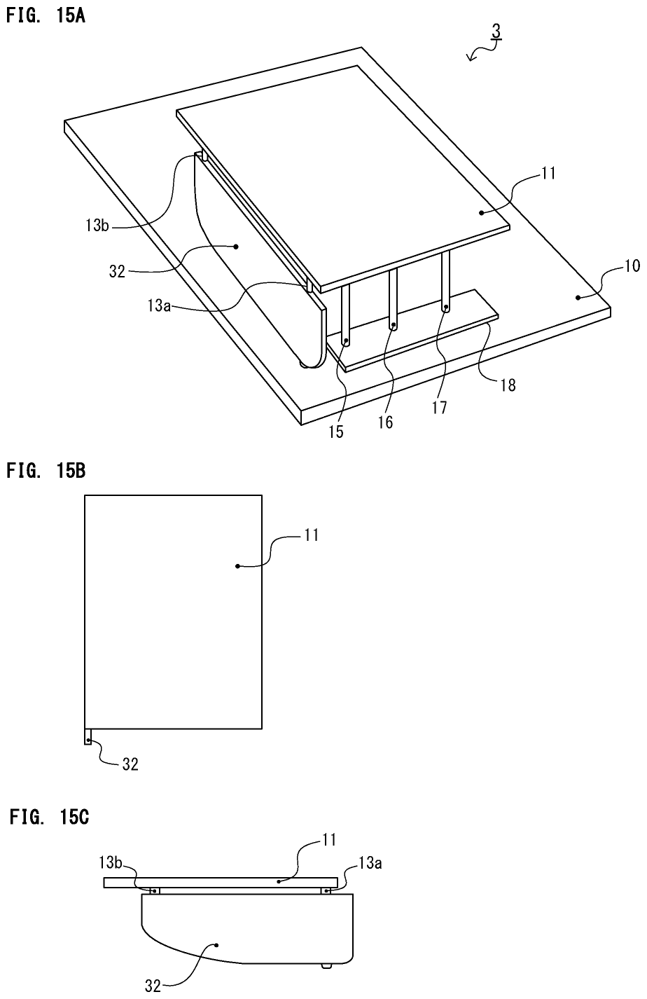

FIG. 15A is a perspective view of an inverted F antenna according to the third embodiment. FIG. 15B is a top view of the planar part, while FIG. 15C is a side view as seen from the direction of the feeding part. In an inverted F antenna 3 of the third embodiment, the shape and the installation position of the feeding part are different from the feeding part 12 described in the first embodiment. For this reason, parts which are the same as the components indicated in the first embodiment will be denoted with the same signs, and duplicate description will be omitted.

For a feeding part 32 of the third embodiment, the length of the proximity edge is shorter than the long edge of the planar part 11, and correspondingly, the radius of the arc of the fin-shaped portion is also slightly smaller than that of the feeding part 12 in the first embodiment. Also, the end of the proximity edge is disposed at a non-opposing position with respect to the planar part 11. In other words, the end of the proximity edge is disposed at a position projecting out past the short edge of the planar part 11. Like the feeding part 12 of the first embodiment, the electrical length (in this example, the sum of the lengths of the edges) is designed to be a length approximately ¼ of the wavelength λ_{H} of the lowest frequency (1.7 GHz) in the high-frequency band of LTE.

Making the proximity edge of a feeding part 32 shorter than the long edge of the planar part 11 is advantageous because similar effects are obtained even when it is necessary to make the planar part 11 long and thin, for example. In this case, the short-circuit parts 15, 16, and 17 and the first switch circuit 18 may also be positioned on the long edge of the planar part 11. In this case, nothing exists on the short edge of the planar part 11 while the short-circuit parts 15, 16, and 17 and the feeding part 12 exist on the long edge.

Modifications

The first to third embodiments describe examples for the case of a rectangular planar part 11, but rectangular shapes also include diamond shapes and trapezoid shapes. In addition, the planar part 11 is not necessarily required to be rectangular, and may also be circular, near-circular, elliptical, or near-elliptical. The edge in these cases corresponds to a rim that determines the electrical length.

As above, according to the embodiments, it is possible to provide an antenna device which enables signals to be transmitted and/or received stably at a low VSWR over a wide frequency band.

1. An antenna device comprising:
An antenna device comprising:
an inverted F antenna which includes a planar part having a face opposing a grounding surface with a predetermined interval therebetween, a feeding part disposed in a plane forming a predetermined angle with respect to the grounding surface, and a short-circuit part for grounding a portion of the planar part,
wherein each of the planar part and the feeding part has a plate shape, and is physically separated from each other; and
wherein the planar part and the feeding part are electrically connected each other at a frequency less than or equal to a predetermined frequency.

2. The antenna device according to claim 1,
wherein the feeding part has a proximity edge in proximity to the planar part, and at least one of other edges of the feeding part is fin-shaped.

3. The antenna device according to claim 2,
wherein the planar part has a rectangular shape, and
wherein a length of the proximity edge is equal to or less than a length of an edge of the planar part in proximity to the proximity edge.

4. The antenna device according to claim 3,
wherein a portion of the proximity edge of the feeding part does not face the edge of the planar part in proximity to the portion of the proximity edge.

5. The antenna device according to claim 1,
wherein an electrical length of the planar part is a length which resonates at a frequency in a first frequency band less than the predetermined frequency; and
wherein an electrical length of the feeding part is a length which resonates in a second frequency band higher than the first frequency band.

6. The antenna device according to claim 1,
wherein the planar part and the feeding part are electrically connected through a filter which cuts off signals at frequencies exceeding the predetermined frequency.

7. The antenna device according to claim 6,
wherein the antenna device includes two or more filters, and two adjacent filters are disposed at a predetermined interval or more away from each other.

8. The antenna device according to claim 1,
wherein a plurality of the short-circuit parts are disposed in a plane orthogonal to the feeding part or parallel to the feeding part on the planar part, and
wherein the inverted F antenna is additionally provided with a first switch circuit which selectively grounds one of the short-circuit parts.

9. The antenna device according to claim 8,
wherein the antenna device includes three or more short-circuit parts provided at different intervals.

10. The antenna device according to claim 1,
wherein the antenna device includes only one short-circuit part provided at a site a predetermined length away from an end near the feeding part on the planar part, and
wherein the inverted F antenna is additionally provided with a second switch circuit for selectively putting one of a plurality of paths each having different electrical lengths from the grounding surface in electrical continuity with the short-circuit part.

11. The antenna device according to claim 1,
wherein the antenna device includes two short-circuit parts at sites different lengths away from an end near the feeding part on the planar part, and
wherein the inverted F antenna further includes a second switch circuit for selectively putting one of a plurality of paths having different electrical lengths from the grounding surface in electrical continuity with one of the two short-circuit parts, or in electrical continuity with the other of the two short-circuit parts instead of the one of the two short-circuit parts.

12. The antenna device according to claim 5,
wherein the first frequency band is a low-frequency band of LTE divided into a plurality of sub-bands, and
wherein the second frequency band is a high-frequency band of LTE.

13. The antenna device according to claim 1, further comprising:
a radio wave-permeable housing having a height of 25 mm from the grounding surface,
wherein the inverted F antenna is accommodated in an accommodating space of the housing.

14. An inverted F antenna comprising:
a planar part having a face opposing a grounding surface with a predetermined interval therebetween;
a feeding part disposed in a plane forming a predetermined angle with respect to the grounding surface; and
a short-circuit part for grounding a portion of the planar part,
wherein each of the planar part and the feeding part has a plate shape, and is physically separated from each other; and
wherein the planar part and the feeding part are electrically connected each other at a frequency less than or equal to a predetermined frequency.
